(19) United States
(12) Patent Application Publication
(10) Pub. No.: US 2026/0140975 A1
(43) Pub. Date: May 21, 2026

(54) TABLE SERIALIZATION WITH EXPLICIT SEMANTICS AND CELL INTERDEPENDENCY RELATIONSHIPS

(71) Applicant: Dell Products L.P., Round Rock, TX (US)

(72) Inventors: Werner Spolidoro Freund, Rio de Janeiro (BR); Claudio Romero, Rio de Janeiro (BR); Eduarda Tatiane Caetano Chagas, Maceió (BR)

(21) Appl. No.: 18/955,886

(22) Filed: Nov. 21, 2024

(51) Int. Cl. G06F 16/332; G06F 16/25

(52) U.S. Cl. CPC G06F 16/3329; G06F 16/258

(57) ABSTRACT

One example method for improving the quality of responses generated by a virtual entity, such as a chatbot, in response to a user query includes, in response to a user query, retrieving content, and metadata associated with the content, from a table that includes cells, representing the content and metadata in a normalized data structure, determining, based on the normalized data structure, cell interdependencies of the table, and performing a content serialization process on the content to transform the content to a natural language structure.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

One or more embodiments disclosed herein generally relate to chatbots and similar digital assistants. More particularly, at least some embodiments relate to systems, hardware, software, computer-readable media, and methods, for extracting content from one or more tables for use in processes such as responding to a query.

### BACKGROUND

Chatbot applications powered by large language models provide ways to enhance business productivity. They can break information silos and increase the agility of navigating enterprise-level content. Retrieval Augmented Generation (RAG) is ubiquitous approach for such applications which combines information retrieval with content generation. Given a query such as from a user to a chatbot or other digital assistant, an information retrieval process is performed in which information relevant to the query is searched and retrieved from indexed databases. This is the information retrieval element. The information that has been retrieved is then passed to a Large Language Model (LLM) which generates an answer to the query. This is the content generation element. The aforementioned approach is currently the state-of-the-art mechanism to ground LLM responses with fresh or confidential information.

In large scale RAG systems, content is typically indexed and stored through an ingestion pipeline. The strategy employed in the ingestion pipeline directly affects information retrieval efficiency. A common pattern for information retrieval is based on semantic search. It computes a proximity function between the query embedding and the indexed content embedding. The creation of content embeddings typically involves a process of chunking content into several small pieces that fit input size of embedders.

Current applications typically rely on general-purpose embedders due to their versatility. Because they are not optimized for a particular task or content representation, the efficacy of such general-purpose embedders is typically poor for more specific content such as might be found in confidential documents, for example. On the other hand, training a task-specific embedder hinders versatility of the RAG system, which is intended to operate as a generalist.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of Llama-index main processing stages.

FIG. 2 discloses aspects of example formatted tables in documents, such as may be employed in connection with one embodiment.

FIG. 3 discloses an example of an ingestion pipeline that includes table content processing and serialization, according to one embodiment.

FIG. 4 discloses example components for table content serialization, according to one embodiment.

FIG. 5 discloses examples of interdependency entities and relationships as represented in graph data structure, according to one embodiment.

FIG. 6 discloses some example experimental results for one embodiment.

FIG. 7 discloses aspects of a computing entity configured and operable to perform any of the disclosed methods, processes, and operations.

### DETAILED DESCRIPTION OF SOME EXAMPLE EMBODIMENTS

One or more embodiments disclosed herein generally relate to chatbots and similar digital assistants. More particularly, at least some embodiments relate to systems, hardware, software, computer-readable media, and methods, for extracting content from one or more tables for use in processes such as responding to a query.

Among other things, one or more embodiments are concerned with methods and pipelines for transforming data contained into a table in such as way as to enable generation of responses, such as by an LLM for example, to a user query. One embodiment may be employed in connection with digital assistants such as a chatbot for example, but the scope of this disclosure, and the application of one or more embodiments and claims, is not limited to that example application.

An example of one such method, according to an embodiment, comprises a data ingestion method and pipeline that performs table processing. In one embodiment, a table such as may be employed in one embodiment comprises various different types of data, and the table may comprise any of a variety of different structures which may range from simple to complex. A method according to one embodiment may comprise operations including, but not limited to: retrieving content and associated metadata from the table, and representing the retrieved materials in a normalized data structure; determining cell interdependencies of the table; performing a content serialization process on the retrieved content to transform that content to a natural language structure.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a general-purpose LLM may be used to obtain table content, and associated metadata such as semantics, from a table. An embodiment may implement a table serialization strategy that aligns table content with query inputs presented to a RAG system. Various other advantages of one or more embodiments will be apparent from this disclosure.

### A. REFERENCES

Reference may be made herein to various documents. These documents, listed below, are incorporated herein in the respective entireties by this reference.
[1] Unstructured Framework. Unstructured|The Unstructured Data ETL for Your LLM, 2024.
[2] Python Tabulate Library. GitHub—astanin/python-tabulate: Pretty-print tabular data in Python, a library and a command-line utility. 2024.
[3] Sebastian Riedel, Douwe Kiela, Patrick Lewis, Aleksandra Piktus, “Retrieval Augmented Generation: Streamlining the creation of intelligent natural language processing models”, Sep. 28, 2020. https://ai.meta.com/blog/retrieval-augmented-generation-streamlining-the-creation-of-intelligent-natural-language-processing-models/.
[4] Patrick Lewis, Ethan Perez, Aleksandra Piktus, Fabio Petroni, Vladimir Karpukhin, Naman Goyal, Heinrich Küttler, Mike Lewis, Wen-tau Yih, Tim Rocktäschel, Sebastian Riedel, Douwe Kiela, “Retrieval-Augmented Generation for Knowledge-Intensive NLP Tasks”, Apr. 12, 2021. https://arxiv.org/abs/2005.11401v4.

### B. ASPECTS OF AN EXAMPLE CONTEXT FOR ONE OR MORE EMBODIMENTS

Following is a discussion of aspects of an example context for various embodiments. This discussion is not intended to limit the scope of the claims or this disclosure, or the applicability of the embodiments, in any way.

### B.1 Retrieval Augmented Generation (RAG)

Retrieval Augmented Generation (RAG) is a process by which a large language model (LLM) is fed with a query and with data that contains the answer to that query. The LLM is then constrained in such a way that its answer to the query should not deviate from the content given as input. RAG was originally proposed in 2020, see, e.g., [3] and [4], but its popularity has significantly increased and it is now considered by some as the state of the art approach for achieving more reliable, up-to-date, and factual outputs from LLMs.

One implementation of RAG typically breaks documents into chunks of raw text that populate a set of databases that are then used as sources for question-and-answering. Those chunks are transformed into a vectorial representation, in what is referred to as an ‘embedding’ process with some language model and stored into a vector database, which indexes them. The language model used for embedding the chunks may be the same used to answer the user queries. Typically, however, a lighter model, that is, a model with relatively fewer parameters, is employed. The chunks are stored with metadata indicating the original source document. Additionally, other metadata may be associated with the chunks, such as authorship and other characteristics, which may be stored in the vector database or elsewhere, in structured or unstructured format.

When the user submits a query to the LLM, that query is first embedded with the same language model used to embed the document chunks. The embedded query is then used to search the most similar chunks in the vector database, using the embedded chunk vectors. Similarity in the vector space is typically computed with some distance function such as the Euclidean distance, or cosine distance. This process is referred to as semantic search because the embeddings encode some semantics of the input sentences.

From the top-k most similar chunks, the associated documents, and any additional metadata, are retrieved. Those, in turn, will be used to assemble the input, also referred to as a ‘context’ or ‘prompt,’ for the LLM. Typically, the input follows a template having some natural language instruction for the LLM, the query to be answered, and the document contents to be summarized.

RAG implementations usually vary in the choice of the language model for the embeddings, the chunking strategy used for source documents, the types of metadata associated with the chunks, how the documents associated with the chunks are accessed and processed, how the LLM input is assembled, and in the choice of the LLM itself.

### B.2 Development Environment

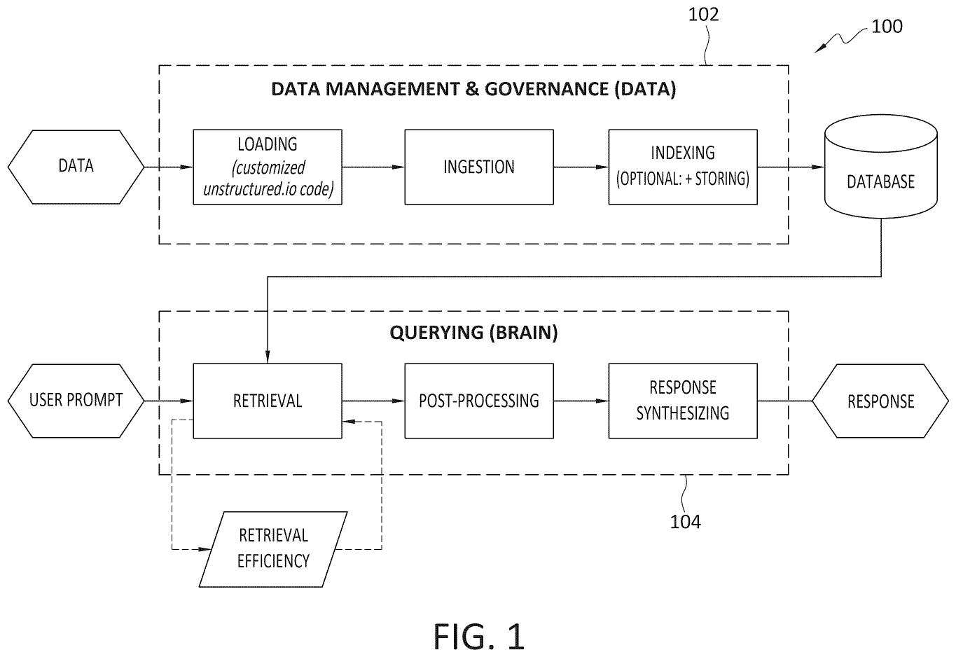

Llama-index is an open-source RAG framework whose main steps are depicted in pipeline 100 disclosed in FIG. 1. In an initial data management stage 102, a data catalog is created by loading, ingesting, indexing, and possibly storing relevant content. Then, each user prompt goes through a querying pipeline 104 composed of information retrieval, post-processing and response synthesis, that is, response generation.

By way of contrast with such conventional approaches, one or more embodiments, discussed in more detail below, may comprise a table serialization strategy which enhances retrieval efficiency when employing general-purpose embedders. In one embodiment, the data of interest is in pptx, docx and pdf formats, which involves customizing llama-index loading step. Thus, an embodiment may be built upon an unstructured framework while customizing the framework to enhance table metadata availability. One embodiment is connected to llama-index with an ingestion pipeline to evaluate retrieval efficiency. Experimental results associated with this particular example embodiment are described elsewhere herein.

### C. OVERVIEW OF ASPECTS OF ONE OR MORE EMBODIMENTS

### C.1 Introduction

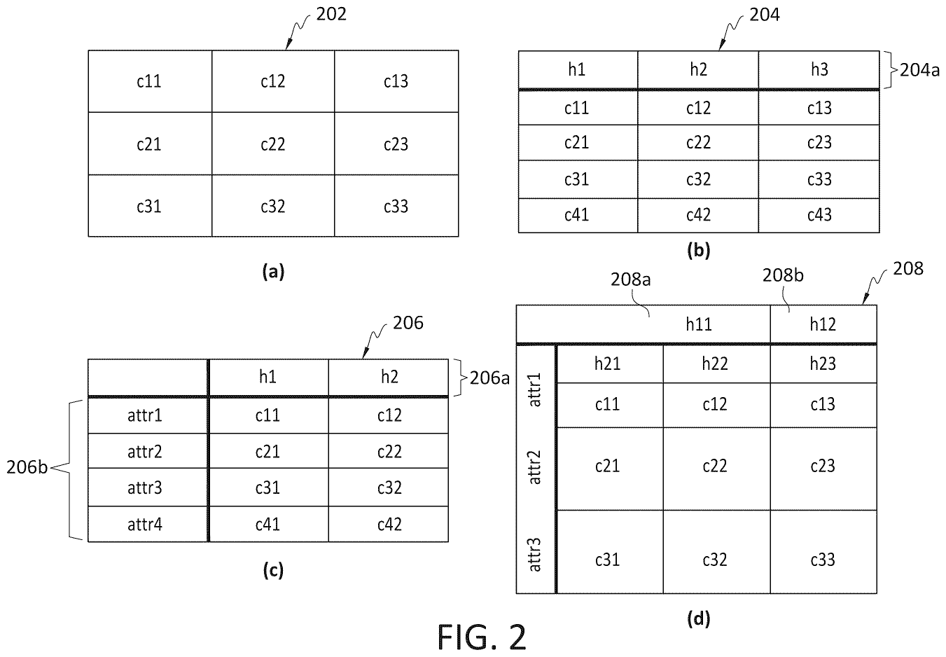

One or more embodiments comprise a table serialization approach that can be efficiently parsed for semantic search while relying on general-purpose embedders. With reference now to the examples disclosed in FIG. 2, details are provided concerning various challenges addressed by one or more embodiments. In general, FIG. 2 discloses various examples of formatted tables in documents, such as may be employed in one or more embodiments. In (a), table 202 content is presented in a grid format without specifying interdependencies between cell content. Simple interdependencies are presented in tables 204 (b) and 206 (c), where table headers 204a, 206a and attributes 206b are provided, therefore implicitly determining content groups. In table 208 (d), a more complex interdependency is specified using a multi-level 208a and 208b header. Many other implicit interdependencies can occur. Additional complexities arise due to several approaches to serialize each table, typically not aligned with retrieval inputs.

### C.2 Discussion

While they are commonly used as a content form, general-purpose embedders are not well suited for capturing semantics available in a table structure. This may be due to a variety of reasons, examples of which are discussed hereafter.

One such reason is that semantic information may be implicit, or unavailable. For instance, in a long table or a table with cells with long textual content, important semantic properties of the cell may not be available in the context window of the embedder. Considering the example of table 204 in FIG. 2 (b), this occurs when the content of header h3 for cell 43 is not within an embedder context window, or when that content is presented in such a way that interdependency between header h3 and cell 43 is lost.

Further, even if the interdependency relationships of cells are available, the general-purpose embedder may not have properly captured the structure used to serialize the table content in training data. For instance, using latex or html serialization for the table 208 in FIG. 2(d) is very likely to provide a representation holding all interdependencies for cell c11, but there is no guarantee that the embedder learned how to infer such interdependencies from training data. This problem increases as more complex interdependencies arise, which is especially true in the case of tables built for communication purposes that are highly visual in their nature such as, for example, tables configured such that their visual structure/formatting impart additional context/relationships to the data.

Another reason that a general purpose embedder may fail to capture semantic information from a table concerns the fact that there are various ways to serialize table information as text such as html, latex, and markdown, for example. This can result in systematic behaviors affecting embedder efficiency specially when considering that the query is not necessarily targeted at a specific table representation. Moreover, the query is generally presented in natural language format, which results in additional complexities for achieving a proper match between table content and the query. In other words, table serialization schemes were not developed to be parsed by language models such as LLMs, and therefore do not focus on maintaining both interdependency relationships and semantics in a structure typically available in training data of general-purpose embedders and aligned to queries.

In light of these concerns, among others, an embodiment may operate to train general-purpose embedders to better align them to the structure of the content of an organization content, including content contained in tables. Thus, one or more embodiments may normalize a table serialization strategy to minimize problem complexity, so as to produce higher training statistical efficacy. That is, an embodiment may represent all the content of an organization content in a single effective structure for the purpose of semantic search, which may enable the efficient optimization of general-purpose embedders, so that they can better capture the structure of a table. In this respect, at least, the use of general-purpose embedders in one embodiment may be counterintuitive, since such general-purpose embedders are not typically well suited for capturing semantics from a table structure.

Further, an embodiment may ensure that relevant semantic information captured from a table, or tables, is presented in a format that better matches standard search queries to increase retrieval efficacy. This means that the serialization choice facilitates aligning table information with user queries.

### D. DETAILED DISCUSSION OF ASPECTS OF ONE OR MORE EMBODIMENTS

### D.1 Introduction

Some example embodiments comprise a pipeline and/or method for serializing table content by capturing cell interdependencies and representing semantics in alignment with user queries and typical training data used by general-purpose language models. As shown by the example experiment discussed herein, this strategy results in more effective information retrieval. Additionally, an embodiment is expected to improve fine-tuning statistical efficiency and reduce catastrophic forgetting effects due to its better alignment with pre-training data.

A data ingestion pipeline according to one embodiment may comprise various components and functionalities. Such components and functionalities may include, but are not limited to:
1. Content and metadata retrieval: In an embodiment, table content is parsed using dedicated libraries or multimodal models to capture each the content and metadata of each cell. In an embodiment, cell content may comprise its textual value, while metadata may comprise key that may be used to determine cell interdependency within the table. Example of metadata content include, but are not limited to, are table grid line, cell color, text color, text size and further decoration or cosmetics that are used to help guide humans in understanding how to read the table content.
2. Cell interdependency determination: An embodiment may use retrieved cell content and metadata to estimate cell interdependency. For example, cells in the same grid line of a table can be grouped to identify a section, header, or attribute interdependency with remaining cells. The estimation strategies may be based on heuristics or data-driven approaches. One embodiment employs heuristics. Interdependency can be represented in any valid data format, such as graph representation for example.
3. Content serialization: Using a cell interdependency representation, content serialization may be performed, in one embodiment, with a focus on maximizing its alignment with user queries and training data of general-purpose language models. This serialization strategy may ensure that cell interdependencies are maintained while chunking content. In other words, table content is serialized as text typically encountered in written documents while keeping cell interdependencies explicitly available.
   Thus, one embodiment does not require any modification in the data retrieval step performed in response to a query, where the semantic search can be performed in a conventional manner. Likewise, an embodiment may not require any additional step for fine-tuning models with the serialization approach according to one embodiment.

As disclosed herein, one or more embodiments comprise an improved, relative at least to the conventional approaches noted herein, table serialization strategy directed, but not limited, to the information retrieval step of RAG systems. Thus, one or more embodiments may comprise various useful features and aspects, although no embodiment is required to possess any of such features or aspects. The following examples are illustrative, but not exhaustive.

A serialization scheme according to one embodiment respects cell interdependency and represents semantic information in a structure aligned to typical query inputs presented to RAG systems. As another example, an embodiment of a serialization scheme maintains information aligned to the structure typically available in training data of general-purpose embedders, therefore providing an off-the-shelf working strategy. As a final example, by better aligning data with natural language, an embodiment may increase statistical efficiency when using such serialization approach for fine-tuning LLMs. It is noted that as used herein ‘statistical efficiency’ refers to convergence rates to optimal values as a function of training data samples employed.

In contrast with one or more embodiments, such as those described above, Unstructured.io (see [1]) serializes table content using “plain” formatting from the python tabulate library (see [2]). While this strategy can work for simpler tables, it hinders semantic search and LLM interdependency understanding as described earlier herein. This applies to many other python table serialization strategies focused at improving human content understanding via column alignment and separation using common characters. Python tabulate also supports formats used to render formatted tables such as html and latex, however these are also subject to same limitations discussed earlier herein. Finally, while there are strategies based on the use of LLM agents for determining how to obtain table content, those strategies are only appropriate for the generation step and cannot be used for semantic search or fine-tuning.

### D.2 Discussion

One embodiment comprises a table content serialization approach that makes cell interdependencies explicit and represents its semantics in a natural language structure that is aligned with user queries and common training data samples of general-purpose embedders. This leads to better retrieval efficacy and may improve statistical efficiency when fine-tuning such embedders.

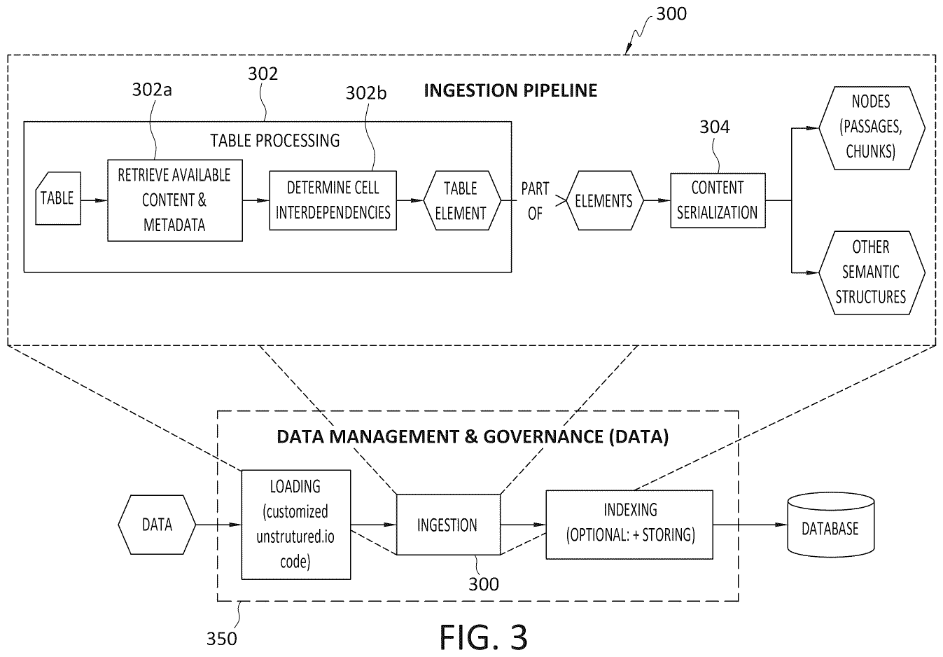

With attention now to FIG. 3, an ingestion pipeline 300 according to one embodiment is disclosed. Particularly, FIG. 3 discloses various components that may be employed in an embodiment for table content serialization providing explicit cell interdependency relationships. Following is a discussion of three components, each of which may be implemented as a respective module, of a table processing pipeline 302 according to one example embodiment. Such components may comprise, for example, a process 302a to retrieve available content and metadata, a process 302b to determine cell interdependency, and a process 304, which may or may not be an element of the table processing pipeline 302, for content serialization. As shown in the example of FIG. 3, the ingestion pipeline 300 may be an element of an overall data management and governance pipeline 350.

### D.2.1 Retrieve Available Content and Metadata

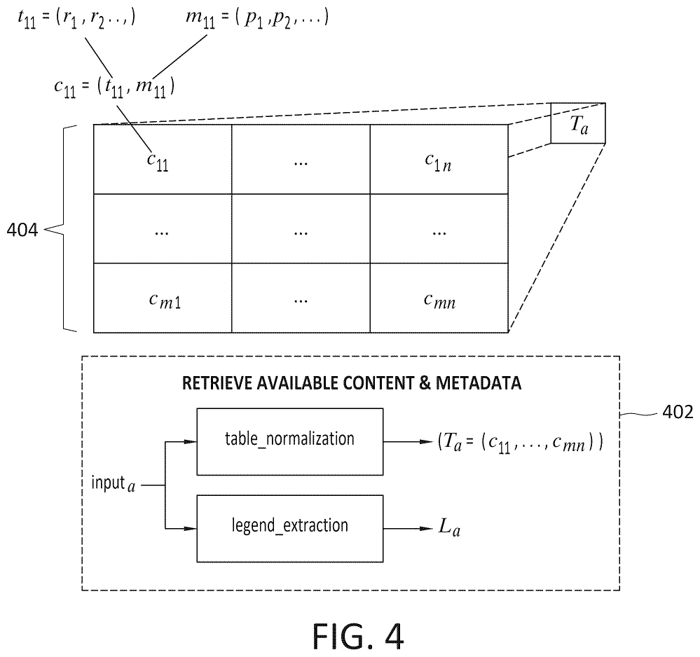

The purpose of this module 302a is to capture the table content and metadata, representing them in a normalized data structure. With attention now to the non-limiting example of FIG. 4, the nomenclature below is employed. In general, FIG. 4 discloses components used in an embodiment for table content serialization providing explicit cell interdependency relationships.

In more detail, a function implemented by a ‘retrieve available content & metadata’ module 402 may be performed with respect to content of a table 404. In an embodiment, and as shown in FIG. 4, this function parses an inputₐ to a normalized table data structure Tₐ using the function table_normalization. The inputₐ may, or may not, already reside in the table 404 when the parsing is performed.

Further, the inputₐ may comprise multiple different data modalities, both structured and unstructured. Some example data modalities present in a table and used in one or more embodiments include, but are not limited to: text parsed by renders such as latex, html and markdown; text printed from applications, such as python tabulate or pandas libraries; structured data from applications such as parsing pptx, docx and pdf content with libraries which can recover all details used to render the table; and, images of rendered text.

With continued reference to the example of FIG. 4, the function table_normalization may be implemented in various different ways, depending upon on the particular inputₐ present, or expected to be present, in a table. The following are examples of different forms of the function table_normalization when retrieving information from a table or tables: (1) for retrieving only an image or images, the function table_normalization may take the form of a visual transformer; (2) for retrieving both images and text, the function table_normalization may take the form of a multimodal transformer; (3) for retrieving text, the function table_normalization may take the form of a language interpreter mapping the input to the normalized data structure; and (4) for retrieving structured data generated by applications, the function table_normalization may take the form of a normalization layer to the common data structure.

As further indicated in the example of FIG. 4, the output Tₐ of the function table_normalization comprises a grid of cells cᵢⱼ. In an embodiment, each cell cᵢⱼ is a tuple of form cᵢⱼ=(tᵢⱼ, mᵢⱼ) where tᵢⱼ is the content of the cell, and mi is the metadata of the cell, where: (1) tᵢⱼ is a set of runs, that is, tᵢⱼ={r₁, . . . , rₖ, . . . , rₙ}; (2) a run rₖ comprises raw textual content—possibly a computational text representation some encoding, such as Unicode—and textual metadata, such as a set of key-value pairs for example—some example key-value pairs include, but are not limited to, font type, font size, bold, italic, underline, strike, and text color; and (3) mi is a set of key-value pairs—example keys include, but are not limited to, cell grid lines with various boundaries, width, and color), and merges with other cells. In an embodiment, a legend may be extracted from a table. The legend may be used to decode metadata into explicit semantics.

### D.2.2 Determine Cell Interdependency

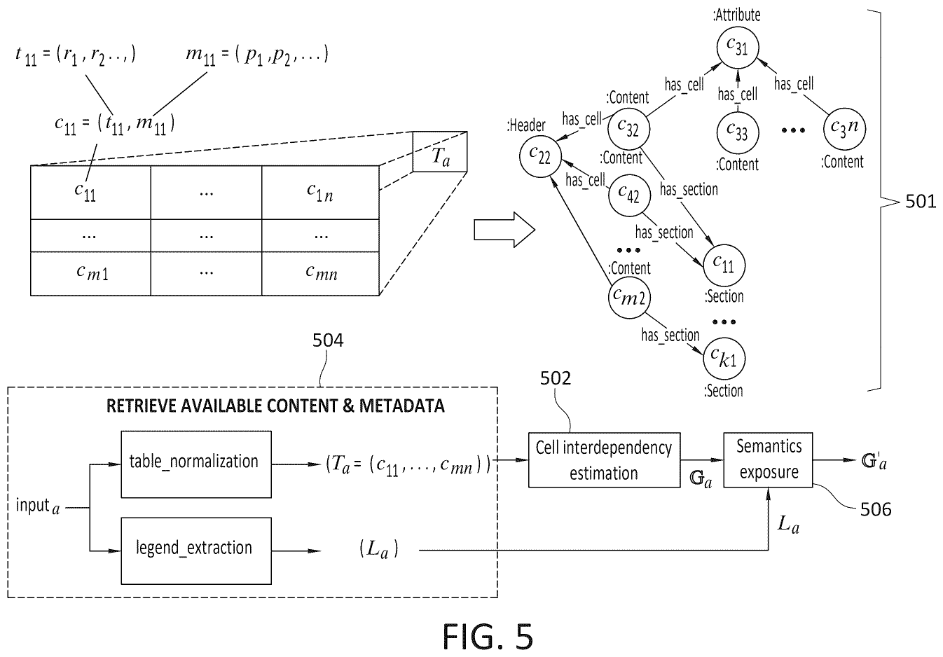

In an embodiment, a cell interdependency estimation process receives as input Tₐ (see, e.g., FIG. 4) and outputs cell interdependency entities and relationships in the form Gₐ as disclosed in the example of FIG. 5, which discloses a ‘cell interdependency estimation’ module 502, or simply ‘module 502,’ that receives input from a ‘retrieve available content & metadata’ module 504, one example of which is discussed above in connection with FIG. 4. More specifically, FIG. 5 discloses an example of interdependency of entities and relationships as represented in a graph data structure 501. Operations of the example module 502 are discussed immediately below.
1. For each cell cᵢⱼ in Tₐ:
   a. Obtain cell entity type lᵢⱼ=NER(cᵢⱼ, Tₐ; θ_{NER}).
      i. NER functional form can be determined by heuristics, data-driven approaches, or a combination of both—no particular technology employed to extract cell interdependency is required however.
         1. However, following a data-driven path enables a more versatile method that can extract cell interdependency from several table description formats. As previously noted, known table formats can have their interdependencies determined through rules. It is noted that, in an embodiment, training data for the latter approaches may be generated by:
         a. using LLMs (large language models) to generate interdependent content automatically and keep the labels of its structure to train the inversion model.
         b. rendering content in textual form available on the internet (latex, html) and introducing data augmentation mechanisms.
         2. In an embodiment, heuristics can be defined based on cᵢⱼ=(tᵢⱼ,mᵢⱼ) values. As an example, let NER={ƒ₁∘ƒ₂∘ . . . } where ∘ symbol determines sequential application of each heuristic function ƒᵢ. Then, possible heuristic functions employed include:
         a. Sequentially evaluating initial rows for header patterns, such as groups of cells delimited by different metadata properties with respect to other cells (potential indicators are presence of different grid lines, usage of bold fonts, different background colors etc.). These cells are assigned :Header type.
         b. Sequentially evaluating initial columns for attribute patterns in a similar fashion to headers. These cells are assigned Attribute type.
         c. Evaluating for subheader/subattribute patterns in horizontally/vertically (respectively) merged cells. Likewise, these are assigned :Header or :Attribute type with a level property indicating its depth.
         d. Evaluating for table sections, namely, a row with a single merged cell splitting the table content. Such row is assigned the :Section type and its tᵢⱼ content is included as a property.
         e. If cell does not fit any previous rules, then it is assigned to a default type. Here, it is assigned to :Content type. These are only example general cell types, and may vary based on each application.
         3. In an embodiment, a more complete strategy can start with heuristics and, when they do not completely match, fall back to a data-driven approach.
2. For each entity type lₓ ϵTₐ:
   a. For each cell cᵢⱼ of type lₓ:
      i. For each cell cₖₗ of type l_{y} where Cₖₗ≠cᵢⱼ:
         1. Compute e_{kl,ij}=RE(cᵢⱼ,cₖₗ, lₓ, l_{y}, Tₐ; θ_{RE}), where RE is a functional form dedicated to extract cell interdependency relationships.
         a. Like NER, RE can benefit both of heuristics and data-driven strategies.
         b. Example of simple heuristics include:
         i. If lₓ is :Header and l_{y} is :Content and j=l, then e_{kl,ij}=:has_header otherwise e_{kl,ij}=Ø.
         ii. If lₓ is :Attribute and l_{y} is :Content and i=k, then e_{kl,ij}=:has_attribute otherwise e_{kl,ij}=Ø.
         iii. If lₓ is :Section and l_{y} is :Content and k>i and k<i(sₒ)|sₒϵ [symbol] (indicating that content does not belong to other sections), then e_{kl,ij}=:has_attribute otherwise e_{kl,ij}=Ø.
3. Various different data structures can be used to represent Gₐ.
   a. In the example above, only hierarchical interdependency relationships were used, thus tree-based representations such as in json can be applied.
   b. However, for achieving maximal generality, an embodiment may use graph-based representations.
   c. Then, let Gₐ=(Vₐ,Eₐ) where Vₐ is a set of entities of form vᵢ ϵVₐ containing each cell in Tₐ and Eₐ a set of relationships of form eₖ=(vᵢ,τ,vⱼ)ϵEₐ determining their interdependencies. An example of Gₐ is disclosed in FIG. 5.
4. In a final step of an example method to determine cell interdependency, a legend Lₐ may be used to map metadata to explicit semantics whenever applicable.
   a. Let Gₐ′=expose_semantics(Gₐ,Lₐ), which may be output by a semantics exposure module 506, define such remapping. Similarly to the NER and RE functional forms, expose_semantics can be defined through heuristics and data-driven strategies.
   b. As an example, suppose that text in green or red in a table is used to represent qualities where one product is respectively better or worse than another. Then expose_semantics remaps both product cells text to make this semantic information explicit, for instance:
      i. By adding a marker <better>product1 text<\better> and <worse>product 2 text<\worse>. Such markers can be later be identified to the LLM in post-processing step.
      ii. Other strategies can be used, such as requesting an LLM to modify texts to make semantics explicit.

### D.2.3 Content Serialization

A final step of a method according to one embodiment serializes Gₐ′ (see FIG. 5) to a natural language structure as in outputₐ=serialization(Gₐ′). In an embodiment, a serialization function aims include:
to identify a representation that better aligns with user queries and training data of general-purpose language models to maximize retrieval efficiency.
in another approach, the serialization function can be optimized to maximize fine-tuning efficiency, with a potential proxy also being alignment of its output with training data.
   An example of an alignment function could be maximizing the model likelihoods of the next token predictions over the serialized output.
It is noted that this strategy can also be applied to enhance response synthesis by facilitating the ability of the LLM to capture table structure and generate a response that is a better match to the user specifications.

Therefore, algorithmic optimization can be employed using efficiency or alignment measures. Here, as one possible strategy, some serialization approaches can be designed by hand and evaluated using the same metrics. Potential templates for one or more embodiments include:

Strategy 1. A highly versatile serialization template however demanding more context window space:
Prepend a flagging text specifying that table content is interdependent. The serialization approach then loops over all cells of: Content type in Gₐ′, retrieving interdependency relationships and replacing placeholders as specified in a template, for instance (where {flag} is a placeholder):
“‘\
   The following content is related:
   *{section of cell c₂₂}{header of cell c₂₂}{attribute of cell c₂₂}: {text of cell c₂₂}′.
   *{section of cell cₘₙ} {header of cell cₘₙ} {attribute of cell cₘₙ}: {text of cell cₘₙ}’.”
If an interdependency relationship is not available, then it is omitted.
If a cell has no interdependency, only cell text is serialized.

Strategy 2. A more compact approach may try to group hierarchy togethers to avoid unnecessary repetitions during serialization, therefore reducing context window usage:

| | |
|---|---|
| ∘ | A potential template form may be: |
| | ‘‘‘\ |
| | * {section of cell c₂₂}: |
| | * {attribute of cell c₂₂}: |
| | * {header of cell c₂₂}: {text of cell c₂₂}. |
| | * {header of cell c₂₃}: {text of cell c₂₃}. |
| | ... |
| | * {header of cell c₂ₙ}: {text of cell c₂ₙ}. |
| | * {attribute of cell c₃₂}: |
| | * {header of cell c₃₂}: {text of cell c₃₂}. |
| | ... |
| | * {header of cell c₃ₙ}: {text of cell c₃ₙ}. |
| | {section of cell cₖ₂}: |
| | * {attribute of cell cₖ₂}: |
| | * {header of cell cₖ₂}: {text of cell cₖ₂}. |
| | ... |
| | ... |
| | * {header of cell cₘₙ}: {text of cell cₘₙ}.‘‘‘ |

### E. EXAMPLE EXPERIMENTS AND RESULTS

As a proof-of-concept, the inventors implemented a development environment using unstructured to load data and llama-index to perform data ingestion and measure retrieval efficiency as described earlier herein. This example used a document corpus composed of about 400 internal files containing tables in presentation format. In the experiment, several serialization strategies were employed for the same document corpus and their retrieval efficiency measured using 430 Q&A(question-and-answer) pairs created using LLMs and curated by human experts to ensure their quality.

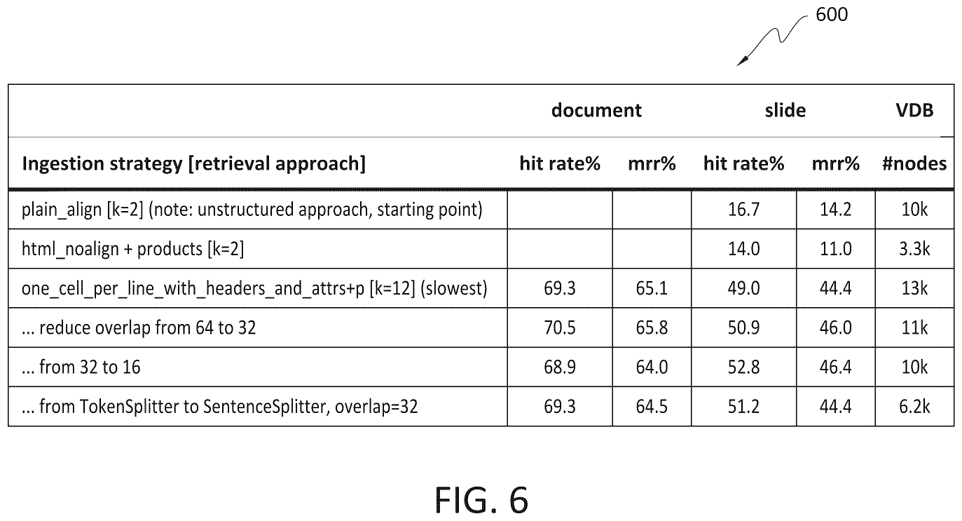

FIG. 6 discloses a table 600 that contains the experimental results, for several different ingestion strategies, as measured by ‘hit rate’ and mean reciprocal rate (‘mrr’). The hit rate indicates the number of times, normalized by the total questions, the retrieval obtained the correct document/slide within the top-k items. In most cases, the experiment employed k=2. The mrr further normalizes the efficiency by its rank-r position (1/r), thus increasing if retrieval strategy results in higher retrieval ranks. The ingestion strategy one_cell_per_line_with_headers_and_attrs matches the description of Strategy 1(above) and, in this experiment, resulted in superior retrieval efficiency rates with respect to any other serialization approach available, including those employed by available frameworks.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. FURTHER EXAMPLE EMBODIMENTS

Following are some further example embodiments. These are presented only by way of example and are not intended to limit the scope of this disclosure or the claims in any way.

Embodiment 1. A method for improving quality of responses generated by a virtual entity in response to a user query, comprising: in response to a user query, retrieving content, and metadata associated with the content, from a table that comprises cells; representing the content and metadata in a normalized data structure; determining, based on the normalized data structure, cell interdependencies of the table; and performing a content serialization process on the content to transform the content to a natural language structure.

Embodiment 2. The method as recited in any preceding embodiment, wherein the natural language structure is returned to the user in response to the user query.

Embodiment 3. The method as recited in any preceding embodiment, wherein a function is used to represent the content and metadata in the normalized data structure, and a type of the function corresponds to a type, or types, of the content retrieved from the table.

Embodiment 4. The method as recited in any preceding embodiment, wherein the normalized data structure comprises a grid of cells, and each of the cells in the normalized data structure is a tuple having a form [content, cell metadata].

Embodiment 5. The method as recited in any preceding embodiment, wherein the cell interdependencies are determined using a heuristic approach.

Embodiment 6. The method as recited in any preceding embodiment, wherein the cell interdependencies of the table comprise cell interdependency entities and relationships, and the cell interdependency entities and relationships are collectively output as a graph data structure.

Embodiment 7. The method as recited in any preceding embodiment, wherein a legend of the table is used to map the metadata to explicit semantics.

Embodiment 8. The method as recited in any preceding embodiment, wherein the content and metadata are retrieved using a general-purpose LLM (large language model).

Embodiment 9. The method as recited in any preceding embodiment, wherein the natural language structure generated by the content serialization process better aligns, relative to the table, with the user query.

Embodiment 10. The method as recited in any preceding embodiment, wherein the table comprises multiple different data types.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

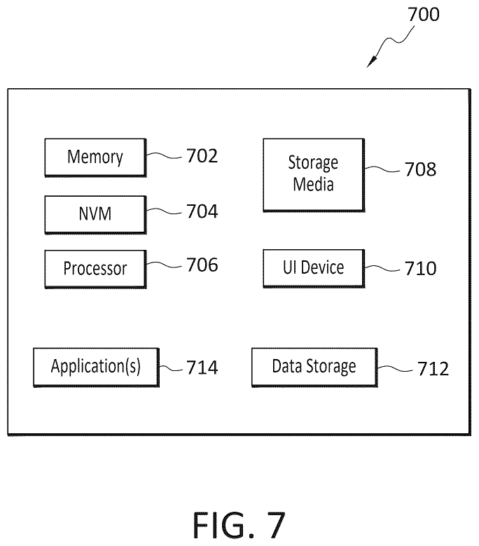

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for improving quality of responses generated by a virtual entity in response to a user query, comprising:
in response to a user query, retrieving content, and metadata associated with the content, from a table that comprises cells;
representing the content and metadata in a normalized data structure;
determining, based on the normalized data structure, cell interdependencies of the table; and
performing a content serialization process on the content to transform the content to a natural language structure.

2. The method as recited in claim 1, wherein the natural language structure is returned to the user in response to the user query.

3. The method as recited in claim 1, wherein a function is used to represent the content and metadata in the normalized data structure, and a type of the function corresponds to a type, or types, of the content retrieved from the table.

4. The method as recited in claim 1, wherein the normalized data structure comprises a grid of cells, and each of the cells in the normalized data structure is a tuple having a form [content, cell metadata].

5. The method as recited in claim 1, wherein the cell interdependencies are determined using a heuristic approach.

6. The method as recited in claim 1, wherein the cell interdependencies of the table comprise cell interdependency entities and relationships, and the cell interdependency entities and relationships are collectively output as a graph data structure.

7. The method as recited in claim 1, wherein a legend of the table is used to map the metadata to explicit semantics.

8. The method as recited in claim 1, wherein the content and metadata are retrieved using a general-purpose LLM (large language model).

9. The method as recited in claim 1, wherein the natural language structure generated by the content serialization process better aligns, relative to the table, with the user query.

10. The method as recited in claim 1, wherein the table comprises multiple different data types.

11. A non-transitory storage medium having stored therein instructions that are executable by one or more hardware processors to perform operations comprising:
in response to a user query, retrieving content, and metadata associated with the content, from a table that comprises cells;
representing the content and metadata in a normalized data structure;
determining, based on the normalized data structure, cell interdependencies of the table; and
performing a content serialization process on the content to transform the content to a natural language structure.

12. The non-transitory storage medium as recited in claim 11, wherein the natural language structure is returned to the user in response to the user query.

13. The non-transitory storage medium as recited in claim 11, wherein a function is used to represent the content and metadata in the normalized data structure, and a type of the function corresponds to a type, or types, of the content retrieved from the table.

14. The non-transitory storage medium as recited in claim 11, wherein the normalized data structure comprises a grid of cells, and each of the cells in the normalized data structure is a tuple having a form [content, cell metadata].

15. The non-transitory storage medium as recited in claim 11, wherein the cell interdependencies are determined using a heuristic approach.

16. The non-transitory storage medium as recited in claim 11, wherein the cell interdependencies of the table comprise cell interdependency entities and relationships, and the cell interdependency entities and relationships are collectively output as a graph data structure.

17. The non-transitory storage medium as recited in claim 11, wherein a legend of the table is used to map the metadata to explicit semantics.

18. The non-transitory storage medium as recited in claim 11, wherein the content and metadata are retrieved using a general-purpose LLM (large language model).

19. The non-transitory storage medium as recited in claim 11, wherein the natural language structure generated by the content serialization process better aligns, relative to the table, with the user query.

20. The non-transitory storage medium as recited in claim 11, wherein the table comprises multiple different data types.
